(19) United States
(12) Patent Application Publication
(10) Pub. No.: US 2004/0130997 A1
(43) Pub. Date: Jul. 8, 2004

(54) Method and device for mastering a copy-protected optical disc and copy-protected optical disc

(76) Inventors: Jean-Louis Duhamel, Morsang S/Orge (FR); Laurent Guenery, Andouille (FR); Gerard Godmer, Crennes/s/Fraubee (FR); Sylvin de Magnienville, Crennes/s/Fraubee (FR); Francois-Xavier Pirot, Alencon (FR)

Correspondence Address: LOWE HAUPTMAN GILMAN & BERNER, LLP, 1700 DIAGNOSTIC ROAD, SUITE 300, ALEXANDRIA, VA, 22314, US

(21) Appl. No.: 10/476,061

(22) PCT Filed: Jun. 4, 2002
(86) PCT No.: PCT/FR02/01891

(30) Foreign Application Priority Data
Jun. 7, 2001 (FR) 01/07685

(51) Int. Cl. G11B 7/00

(52) U.S. Cl. 369/59.25; 369/111

(57) ABSTRACT

The invention relates to a process and a device for the mastering of an optical disk protected against copying and such an optical disk.

The protected disk is of the type with double spiral, in which there exists a protection zone where a secondary spiral (P_{B}) is nested between the turns of a main spiral (P_{A}), the spacing from one turn of a spiral to the adjacent turn retaining the standard value. To allow undisturbed reading by standard readers, there is provision to effect a shift of k sectors between the sectors with the same address (n) on each of the two spirals. Infill zones (F_{Acc}, F_{Dec}) are furthermore provided at the start and at the end of the useful part of the secondary track (P_{B}) so as to avoid the risks of “hole” or of mutual overwriting of the tracks.

The invention applies to optical disks protected against copying and to their manufacture.

The present invention pertains to a mastering process and device for the manufacture of an optical disk protected against copying, of the type comprising a main spiral track and at least one secondary track nested between loops of the main track and to such a disk.

Numerous techniques have been developed, in particular in the last few years, for preventing the illegal copying of optical disks. One of the simplest of them consists in writing an anti-copying protection code at a predetermined place on the disk, during its manufacture. This predetermined place is such that numerous copying techniques cannot reproduce this place on the disk. Readers are made so as to reject disks having no protection code at the right place. However, it is obvious that any device made or modified so as to read all the data of a disk can copy the disk, including its protection code, and the illegal copy obtained is exactly similar to the original disk.

Other relatively sophisticated techniques have been conceived for remedying the unauthorized copying problems. Most of them involve the use of a “signature” or specific imprint on the disk. This may consist of a variation of certain parameters of burning on the disk, such as shape of the marks (depth, width, length), introduction of an asymmetry of the marks, wobulation of the track at particular frequencies, etc. These variations constitute the signature to be searched for and cannot be reproduced by standard writers such as CD-R writers. However, it is necessary that the disk readers detect these variations and this is not generally possible with standard readers. A variant of this method makes it possible to create ambiguous code words capable of being read with different values when the disk is played several times in succession on standard readers.

A different technique consists in deliberately damaging or destroying loops or sectors of the original disk whose addresses can be encrypted so as to construct a code identifying the disk burnt onto the latter. However, a drawback of this type of technique is that it requires that the user of the disk be authenticated by a more or less complex access cue that the user will have to introduce as a key to obtain access to the content of the disk. This cue often has to be requested from an entitlement station. This technique therefore imposes appreciable constraints. Another drawback of such methods of recognizing damaged parts is that it makes it possible to hide only a small quantity of data, which therefore may easily be incorporated into the body of the software. Another drawback is that the writing of such marks is structurally within the scope of commercial disk writers, the only obstacle to the recopying of the disks being that the software for controlling these writers is unsuitable for the management of such marks, errors or omissions. A modification of one of the items of control software (at the level of the user processor or of the internal software of the writer) would however be insufficient to recopy these disks. It may be noted here that the damaging of the disk may ultimately consist in the outright omission of certain sectors.

To attempt to remedy certain of these drawbacks and strengthen the security of anti-pirating systems with hidden codes, techniques have been developed based on an interrupted spiral or on separate zones between which the data are distributed in such a way as to prohibit continuous recording of executable data. Such techniques may, however, entail a reduction in density of the information on the disk or sometimes the use of nonstandard readers.

A seemingly more promising route has been outlined by providing a disk comprising a continuous main spiral or track between whose turns is interposed a secondary spiral piece, the standard pitch or spacing of the tracks of a conventional optical disk being retained. A method of authentication then consists in “recognizing” the secondary spiral only by verifying the presence of specific identifying or address codes which are not located on the main track. However, this technique does not efficiently make the most of the major benefit of employing a zone which is not easily reproducible by a standard writer.

The Applicants have recently proposed to remedy these drawbacks and to make the most of the benefit of the existence of such a zone which makes it possible to eliminate conventional copying with the aid of standard writers, by virtue of the recognition of the physical presence of a two-part protection zone.

This particularly beneficial solution envisages an optical disk protected against copying of the type comprising a continuous spiral main track, disposed over the entire useful part of the disk and the sectors of which have addresses ordered substantially sequentially along this track, and at least one secondary track nested between successive loops of the main track in such a way that the spacing of the loops remains the same over substantially the whole of the disk, sectors of the secondary track and the corresponding sectors of the adjacent part of the main track in a given radial direction bearing the same addresses in such a way as to form two parts of substantially the same size of a protection zone.

To implement the process for protection against copying with such a disk, reading of the two parts of the protection zone that are compatible with standard readers is necessary, in particular the reading of sectors with the same address on the main track and the secondary track; this can be done by making the reader perform a track jump. A difficulty is then encountered in respect of the correct reading of the corresponding sector on the associated track part, in particular when the jump is obtained by requesting reading of a sector preceding the sector currently read. Specifically, after the jump, certain conventional readers need a certain time, hence passage over a certain number of successive sectors, to readjust themselves (focusing, acquisition of an address read, etc.). Moreover, if the sectors with the same address on the main track and the secondary track are opposite one another, certain readers may be disturbed. These difficulties may be manifested by the fact that readers will recommence jumps without managing to read the other track.

To remedy this drawback, it is proposed that a shift of k sectors between the sectors of like address of the two tracks be introduced into the protection zone, in such a way that almost all readers can, by successive jumps, successfully read one and the same address on both of the two tracks.

The manufacture of such a disk necessitates a modification of the known mastering processes in such a way as to incorporate therein the possibilities of producing double spiral and predetermined shifts between the sectors of the two tracks.

According to a first aspect of the invention, there is therefore provided a mastering process for an optical disk protected against copying of the type comprising a continuous spiral main track, disposed over the entire useful part of the disk and the sectors of which have addresses ordered substantially sequentially along this track, and at least one secondary track nested between successive loops of the main track in such a way that the spacing of the loops remains the same over substantially the whole of the disk, sectors of the secondary track and the corresponding sectors of the adjacent part of the main track in a given radial direction bearing the same addresses in such a way as to form two parts of substantially the same size of a protection zone, in which the mastering is performed with the aid of a burning beam source receiving the encoded information for burning from a formatter device, said process being characterized in that it comprises the steps of:

Providing the information encoded with the aid of a formatter to two outputs respectively delivering the information to be burnt onto the main track and the information to be burnt onto the secondary track;

Continuously applying the information to be burnt onto the main track to said source;

Instructing, at a predetermined instant before the chosen start of the useful part of the secondary track, an acceleration of the displacements in said source so as to go from a given initial track spacing to double spacing by way of an acceleration zone;

Applying said information to be burnt onto the secondary track to said source with a shift of k sectors with respect to the burning of the start sector of the part of the protection zone on the main track, where k is any predetermined algebraic number;

Instructing, at a predetermined instant after the end of the useful part of the secondary track, a deceleration of the displacements in said source so as to go from said double spacing to said initial spacing by way of a deceleration zone.

One of the problems that arises during mastering operations for the manufacture of such a disk is that the instructing of a beam source for burning two tracks in parallel does not allow deterministic control of the start and end of zone addresses with two tracks. There is thus a risk of finishing up either with “holes” where the main track is at a spacing double the standard spiral spacing without the secondary track being present (latter begins too late or end of double spacing of the main track occurs too late after the end of the secondary track) or in a mutual overwriting of the tracks if the secondary track begins too soon or if the main track reverts to its standard spacing too soon.

To remedy this, the invention makes provision to initiate and prolong the useful part of the secondary track by zones with infill information that can be played on to avoid “holes” and overwriting.

This introducing of infill information requires, during mastering operations, self-synchronization on the actual position of the acceleration and deceleration zones and, according to the invention, the burning beam source is therefore designed or modified to provide information for synchronization on the actual start of the acceleration and deceleration zones.

According to another aspect of the invention, there is also provided a mastering process as above, characterized in that it furthermore comprises the steps of:

Applying start infill information to said source for burning onto the secondary track up to the start of its useful part, from the end of a first predetermined timeout interval after said start of acceleration zone synchronization information;

Applying end infill information to said source for burning onto the secondary track from the end of its useful part, up to the end of a second predetermined timeout interval after said start of deceleration zone synchronization information.

The subject of the invention is also a mastering device that implements the above process.

The invention also relates to an optical disk protected against copying of the type comprising a continuous spiral main track, disposed over the entire useful part of the disk and the sectors of which have addresses ordered substantially sequentially along this track, and at least one secondary track nested between successive loops of the main track in such a way that the spacing of the loops remains the same over substantially the whole of the disk, sectors of the secondary track and the corresponding sectors of the adjacent part of the main track in a given radial direction bearing the same addresses in such a way as to form two parts of substantially the same size of a protection zone, said disk being characterized in that two sectors with the same address in the protection zone are shifted by a interval of k sectors as measured along the main track, k being any predetermined algebraic number.

As indicated above, it is preferable to insert infill information zones at the start and end of a secondary track.

The invention therefore also provides for a disk as above, in which the passing from the main track zone, with given initial spacing of the spiral, to the start of the protection zone, with spacing of the main track double the initial spacing, and the passing from the end of this protection zone to the main track zone with initial spacing are performed respectively by an acceleration zone and a deceleration zone, said disk being characterized in that the useful part of the secondary track is preceded and followed by burnt infill information starting in the acceleration zone up to the start of the useful part on the one hand and extending, on the other hand, from the end of the useful part up until the deceleration zone.

The invention will be better understood and other characteristics and advantages will become apparent with the aid of the following description and of the appended drawings where:

FIG. 1 is a representation in linear form of the spiral turns of a protected disk;

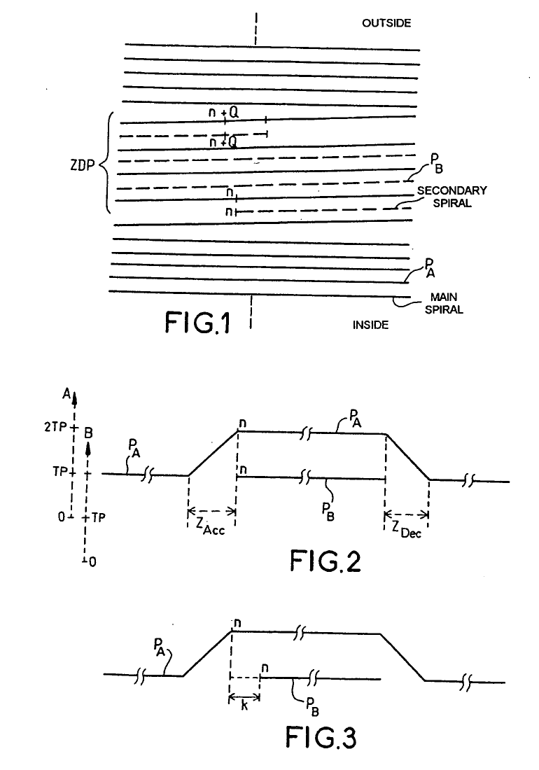

FIG. 2 is another linear representation of a protected disk with secondary track;

FIG. 3 shows the representation of FIG. 2 modified according to a first aspect of the invention;

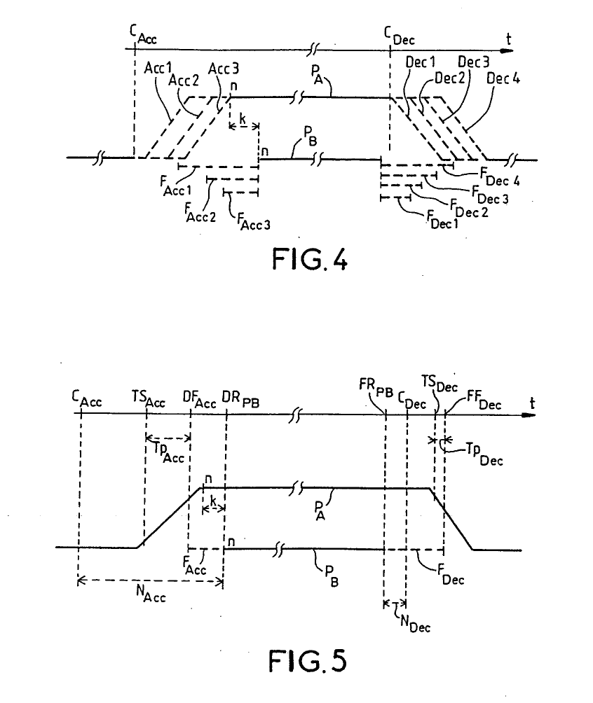

FIG. 4 is a representation illustrating another problem solved by the invention;

FIG. 5 represents a timing diagram of the mastering operations according to the invention;

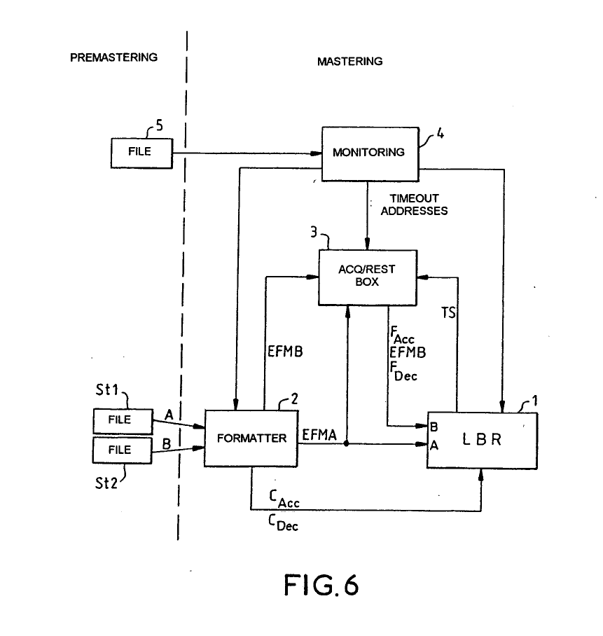

FIG. 6 is a block diagram of an embodiment of a mastering device according to the invention.

Represented in FIG. 1 is a preferential form of protected disk, in which each loop (or turn) of a spiral track is represented by a segment stretching from the extreme left to the extreme right of the figure. Likewise, indicated toward the bottom of the figure is the inside of the disk, where a main spiral track P_{A} begins, and the outside of the disk where this track finishes.

The main track P_{A} is a continuous spiral track disposed over the whole of the useful part of the disk and whose sectors have, in a conventional manner, addresses ordered substantially sequentially along this track. A secondary track P_{B} is interposed between successive loops of the main track, in such a way that the spacing of the track remains, substantially in all the zones of the disk, constant and equal to the standard spacing customarily used in conventional optical disks, such as CD- or DVD-ROM disks. The two-part zone in which the two tracks coexist and in which the same addresses n to n+Q are used on the two tracks is called the “protection zone” ZDP. This zone comprises information emanating from a protection file and distributed between the main and secondary tracks. An essential element of the protection is the recognition of the physical structure of the original disk with two tracks which differentiates it from a copy with a single track and is based on the successful reading by a standard reader of the information present at the same addresses on the main track and the secondary track, by virtue of a series of reads under different conditions and/or of the search on the associated track for a sector with the same address as the sector read on a first track.

FIG. 2 represents the disk of FIG. 1 in another diagrammatic form where the double spiral is represented linearly. The disk comprises firstly a continuous main spiral P_{A}. If we imagine that we are starting from the inside of the disk, on the left in the figure, we find firstly the spiral P_{A} alone, with a spacing TP (scale A on the left) which is a standardized spacing, for example 1.6 μm for CD-ROM disks. Then, the spacing increases progressively in a zone Z_{Acc}, called the acceleration zone for reasons that will be made precise later, until it reaches a double spacing 2TP. The spiral P_{A} continues with this spacing 2TP in the protection zone where it coexists with the secondary track P_{B} nested between its turns and also having a spacing 2TR (scale B on the left of the figure). This two-track protection zone is followed by a zone Z_{Dec}, called the deceleration zone, where the spacing of the spiral P_{A} decreases progressively until it reverts to the standardized value TP. The spiral P_{A} then continues alone with this spacing TP up to the end of the useful part of the disk. As may be seen in this FIG. 2, the sectors with address n on the tracks P_{A} and P_{B} are theoretically disposed opposite one another.

However, as was pointed out earlier, certain standard readers need, when they make a track jump, a certain time (varying from one reader to another) to self-adjust and actually read the information burnt onto the track reached. Moreover, identical addresses on the adjacent sectors of the tracks P_{A} and P_{B} disturb the readers since, in the case of a jump, they have “the impression of treading water”.

To remedy this, use is made of a first characteristic of the invention shown diagrammatically in FIG. 3. There is provided a shift gap of k sectors between the sectors of like address (n for example) on the main track and the secondary track. Considered by way of example here is the case where the secondary track is on “the inside the disk” with respect to the main track, that is to say that a sector with address n of the secondary track which, in theory, would be facing a sector with address n of the main track, is facing the sector with address n+k of the main track and toward the inside of the disk in the radial direction with respect to this sector n+k. This layout is particularly necessary if the strategy adopted for jumping from one spiral to another is to search for a sector by a backward jump. For the optimization of the system, it is desirable for the number k of shift sectors to correspond approximately to the content of half a turn of a spiral. As, in the usual case where the disk is read at constant linear velocity (CLV), a turn of a spiral contains more sectors toward the outside of the disk than toward the inside, it can be deduced from this that the readers have more time to self-adjust when the secondary track is displaced toward the outside of the disk. Naturally, the invention also applies when the secondary track is “on the outside of the disk” with respect to the main track and/or when the shift k is in the reverse direction; that is to say the shift k is in fact any predetermined real number.

This said, account must also be taken, for the proper reading of the double spiral, of a phenomenon that normally occurs during mastering operations. The information to be burnt onto the master (generally made of glass) is applied to a burning beam source by a formatter device that encodes data according to the EFM code for CD disks (EFM: the initials of “Eight to Fourteen Modulation”). In the present case, a source capable of burning two tracks in parallel is required. A twin-beam LBR (LBR: Laser Beam Recorder) can for example be used as source. Such an LBR possesses two modulation inputs corresponding respectively to the two coupled beams. The two beams move radially with respect to the master to be burnt which turns at constant speed. Normally, the radial speed of movement of the beams is constant so as to ensure the following of one (or two) spiral with constant given initial spacing. This spacing may be a standardized spacing (1.6 μm for example for CD-ROMs according to the ISO/IEC standard 10149). However, it is possible to operate the servocontrols of the LBR through a control input for accelerating or slowing the radial movement of the beams so as to change the spacing of the spirals.

With such an LBR, experiments for producing a double spiral have shown variability in dealing with the instructions for changing spacing on acceleration or on deceleration, this disturbing the accuracy of the entry and exit of the double-spiral zone. The interval required by the LBR to deal with a change of spacing instruction varies from one machine to another and/or from one master to another. Consequently, one may be confronted either with a zone without pits (or “hole”) if the instruction is processed by the LBR more quickly than envisaged under acceleration or more slowly during deceleration, or with a zone of mutual overwriting of the tracks in the contrary cases.

To remedy this, the acceleration instruction must be issued several sectors before the moment at which the acceleration is desired. However, this generally results in a “hole”, that is to say one or more turns of the main spiral at double spacing without secondary spiral. Likewise, at the end of a secondary spiral, if an appreciable interval appears in dealing with the deceleration instruction, there will also be a “hole” without secondary spiral before the main spiral returns to the standardized spacing TP. Also, it is not possible to anticipate by issuing the deceleration instruction slightly before the end of the secondary spiral since, in case of fast execution, there is a risk of overwriting the end of the secondary track.

FIG. 4 diagrammatically reports these phenomena. Thus, by way of example, it may be seen that, for one and the same acceleration instruction C_{Acc}, three possible patterns of acceleration Acc1 to Acc3 have been represented depending on the reaction times of the LBR. Likewise, FIG. 4 shows, by way of example, four possible patterns of deceleration Dec1 to Dec4 for one and the same deceleration instruction C_{Dec}.

The consequences of these phenomena are appreciable disturbances of reading by standard readers. If there are excessively big “holes”, in the case of enhanced readers that correlate the number of tracks jumped and the actual radial movement of the optical head, the servocontrol of the head detects incoherences during jumps in a “hole” zone, this possibly causing access time problems.

Likewise, a tracks overwriting zone will disturb the readers.

A solution could be to adapt the length of the secondary spiral, hence the amount of information to be burnt so that it is inserted exactly into the space actually created for it.

Another solution has been found according to the invention. As represented in FIG. 4, provision is made to use infill information, in principle with no useful meaning, for initiating and prolonging the secondary track P_{B} so as to plug the empty space (the “holes”) before and after the useful part of P_{B}. Thus, depending on the position of the acceleration zone actually obtained, the infills F_{Acc1} to F_{Acc3} will be used. Likewise, at the end of a secondary track, one of the infills F_{Dec1} to F_{Dec4} will be added.

In practice, to choose the proper duration of the infills, as the exact position of the acceleration and deceleration zones is not controlled in a deterministic manner, the information for actually dealing with the acceleration instruction C_{Acc} and deceleration instruction C_{Dec} must be obtained from the LBR itself. The LBR is designed or modified to provide synchronization information TS_{Acc}, TS_{Dec} appearing as soon as the instruction, C_{Acc}, C_{Dec} respectively, is dealt with.

This said, FIG. 5 illustrates a timing diagram of the mastering operations for a double-spiral master. If DR_{PB} designates the instant at which the burning of the track P_{B} must commence, the acceleration instruction is issued early enough to cover all the possible reaction times, for example N_{Acc} sectors before the instant DR_{PB}.

When the LBR begins the acceleration, it provides synchronization information TS_{Acc}. Onward of this instant, a predetermined timeout Tp_{Acc} will trigger the start DF_{Acc} of the infill information F_{Acc}. Additionally, the secondary track start DR_{PB} corresponding to the sector with address n has been fixed k sectors after the appearance of the sector with address n on the main track P_{A}.

Likewise, at the end of the protection zone, the deceleration instruction C_{Dec} is issued N_{Dec} sectors after the end FR_{PB} of the secondary track P_{B}. Moreover, the infill information F_{Dec} is provided to the LBR right from the end FR_{PB} of the track P_{B}. When the LBR triggers the deceleration, it provides synchronization information TS_{Dec}. Onward of this instant, a predetermined timeout Tp_{Dec} will trigger the end FF_{Dec} of the infill zone F_{Dec}.

FIG. 6 is a diagram of a mastering device implementing the above process. Vertical dashes separate the mastering part from what is obtained during the premastering operations.

The information A and B to be burnt respectively onto the tracks P_{A} and P_{B}, obtained during the premastering, is transferred from files in storage means St1 and St2 (represented separated for the clarity of the description) to the formatter device 2 which encodes them into code EFM and provides the burn signals EFMA for the main track P_{A} and EFMB for the secondary track P_{B}. The signals EFMA are applied to the input A for modulating the main track beam of the LBR, 1. Moreover, the formatter 2 provides acceleration C_{Acc} and deceleration C_{Dec} control signals to a control input LBR. The synchronization information TS_{Acc} for actual start of acceleration and TS_{Dec} for actual start of deceleration is available on an output of the LBR.

There is furthermore provided an acquisition/restoring box 3. The latter receives from the formatter 2 the signals EFMB, as well as the signals EFMA applied to the LBR. It also receives the synchronization information TS (TS_{Acc}, TS_{Dec}) coming from the LBR 1.

This box provides the signals applied to the input B for modulating the secondary track beam. Finally, the box 3 receives various parameters from a monitoring circuit 4 which receives information from a file 5 obtained during the premastering and, on the other hand, may calculate information and/or parameters in situ. This circuit 4 also constitutes the monitoring post for the LBR and for the formatter.

The manner of operation is as follows. During a first acquisition phase, the information EFMB (encoded by the formatter 2) to be burnt onto the secondary track P_{B} is sent by the formatter to the box 3 which places it in memory in storage means. Additionally, the position and the length of the useful part of the secondary track which were determined when creating the protection and placed in the file 5 are sent to the monitoring circuit 4. The latter has, or receives, the timeout parameters suitable for the mastering to be performed.

The restoring phase (referred to thus because the box 3 restores for the burning in particular the signals EFMB stored) comprise the continuous sending to the LBR by the formatter 2 of the signals EFMA, then the sending of the acceleration control signal C_{Acc}. When the signal TS_{Acc} is delivered by the LBR to the box 3, the latter, after the timeout interval Tp_{Acc} provided to it by the monitoring circuit 4, commences sending infill information on the input B of the LBR. This information may be generated by the box 3 or, preferably, be constituted by the signals EFMA themselves which it receives from the formatter.

The box 3 also receives from the monitoring circuit 4 the secondary track start address (determined on the main track) DR_{PB} obtained from the position of this track and the shift k to be performed. Once this address has been detected on the signal EFMA by the box 3, the latter replaces the infill F_{Acc} with the signals EFMB that it has stored.

At the end of secondary track burning, similar steps are undertaken. At the end of restoring address FR_{PB}, provided by the circuit 4, the box 3 replaces the signals EFMB with infill information on the input B of the LBR. The deceleration control signal C_{Dec} is sent to the LBR with a shift of N_{Dec} sectors with respect to FR_{PB}. When the box 3 receives the actual start of deceleration synchronization information TS_{Dec} coming from the LBR, after a timeout Tp_{Dec} fixed by the monitoring circuit 4, the box 3 ceases sending any signal to the LBR, this corresponding to the end FF_{Dec} of the end infill F_{Dec}.

Of course, the exemplary arrangements described are in no way limiting of the invention. In particular, all the operations specific to the invention, instead of being carried out within a separate box, could quite well be integrated for example into the formatter or also into the processing unit (CPU) of the LBR. Moreover, the burning beam source, instead of a twin-beam LBR, could be any beam source capable of burning two tracks in parallel, simultaneously or sequentially. Likewise, although an exemplary arrangement has been described in which the information is encoded in two phases, an acquisition phase, during which the information to be burnt onto the secondary track is encoded by the formatter and stored in memory, and a restoring phase, during which, while burning the information into the protection zone, the stored information is restored to the burning beam source so as to be burnt onto the secondary track, it is also possible preferably subsequently to imagine encoding the information to be burnt “on the fly” (in real time) during the actual operations of burning the main and secondary tracks by the source. The encoded information to be burnt is then provided as and when by the formatter to two outputs.

1. A mastering process for an optical disk protected against copying of the type comprising a continuous spiral main track (P_{A}), disposed over the entire useful part of the disk and the sectors of which have addresses ordered substantially sequentially along this track, and at least one secondary track (P_{B}) nested between successive loops of the main track in such a way that the spacing of the loops remains the same over substantially the whole of the disk, sectors of the secondary track and the corresponding sectors of the adjacent part of the main track in a given radial direction bearing the same addresses (n to n+Q) in such a way as to form two parts of substantially the same size of a protection zone (ZDP), in which the mastering is performed with the aid of a burning beam source receiving the encoded information for burning from a formatter device, said process being characterized in that it comprises the steps of:
Providing the information encoded with the aid of a formatter to two outputs respectively delivering the information (EFMA) to be burnt onto to the main track (P_{A}) and the information (EFMB) to be burnt onto the secondary track (P_{B});
Continuously applying the information to be burnt onto the main track (P_{A}) to said source;
Instructing, at a predetermined instant (C_{Acc}) before the chosen start (DR_{PB}) of the useful part of the secondary track, an acceleration of the displacements in said source so as to go from a given initial track spacing to double spacing by way of an acceleration zone (Z_{Acc});
Applying said information to be burnt onto the secondary track to said source with a shift of k sectors with respect to the burning of the start sector of the part of the protection zone on the main track (P_{A}), where k is any predetermined real number;
Instructing, at a predetermined instant (C_{Dec}) after the end (FR_{PB}) of the useful part of the secondary track, a deceleration of the displacements in said source so as to go from said double spacing to said initial spacing by way of a deceleration zone (Z_{Dec}).

2. The mastering process as claimed in claim 1, characterized in that, in a first acquisition phase, the information (EFMB) to be burnt onto the secondary track (P_{B}) is encoded and stored in memory.

3. The mastering process as claimed in one of claims 1 or 2, characterized in that said burning beam source (1) is designed to provide information for synchronization on the actual start (TS_{Acc}; TS_{Dec}) of the acceleration and deceleration zones.

4. The mastering process as claimed in claim 3, characterized in that it furthermore comprises the steps of:
Applying start infill information (F_{Acc}) to said source for burning onto the secondary track up to the start of its useful part, from the end of a first predetermined timeout interval (Tp_{Acc}) after said start of acceleration zone synchronization information (TS_{Acc});
Applying end infill information (F_{Dec}) to said source for burning onto the secondary track from the end of its useful part, up to the end of a second predetermined timeout interval (Tp_{Dec}) after said start of deceleration zone synchronization information (TS_{Dec}).

5. The mastering process as claimed in claim 4, characterized in that said first and second timeout intervals (Tp_{Acc}; Tp_{Dec}) are chosen so that the burning of the start infill information commences inside the acceleration zone and that the burning of the end infill information terminates inside the deceleration zone.

6. A mastering device for the implementation of the process as claimed in any one of claims 1 to 5, of the type comprising a burning beam source (1) capable of burning two tracks in parallel and of going from a burning zone with given initial track spacing to a zone with double spacing and vice versa by acceleration, respectively deceleration, of the beam displacements in response to acceleration (C_{Acc}), respectively deceleration (C_{Dec}), instruction signals which are applied to it, and a formatter device (2) which encodes the information to be burnt so as to apply it to said source, said mastering device being characterized in that said source is designed to provide signals for synchronization on the actual start (TS_{Acc}; TS_{Dec}) of the burnt acceleration and deceleration zones, and in that it furthermore comprises:
Storage means (3) for the prior acquisition of the information encoded (EFMB) by said formatter device (2) to be burnt onto the secondary track (P_{B});
Restoring means (3) for providing said source (1) with the information to be burnt onto the secondary track including said encoded information stored by said storage means;
Management means (3) for instructing said restoring by the restoring means, from encoded information (EFMA) provided by the formatter device to said source for burning onto the main track (P_{A}) and said synchronization signals received from said source;
Monitoring means (4) for providing said management means, said source and the formatter device with monitoring information.

7. The device as claimed in claim 6, characterized in that said restoring means (3) are designed to generate and provide infill information (F_{Acc}, D_{Dec}) before and after said encoded stored information (EFMB), in that said management means are designed to instruct the restoring means on the basis of the encoded information (EFMA) of the main track, of the synchronization signals coming from said source and of the monitoring information coming from the monitoring means and including the start and end addresses of the useful part of the secondary track, of the position of the latter and of timeout intervals for the start of start infill information and end of end infill information instruction.

8. The device as claimed in claim 7, characterized in that said monitoring means (4) receive length and position information for the useful part of the secondary track and shift information (k) from a file generated during the premastering operations, and timeout intervals, for formulating the monitoring information sent to said management means, to said source and to the formatter device.

9. The device as claimed in one of claims 6 to 8, characterized in that said restoring means are designed to provide as infill information encoded information (EFMA) provided for burning onto the main track by said formatter device (2).

10. An optical disk protected against copying of the type comprising a continuous spiral main track (P_{A}), disposed over the entire useful part of the disk and the sectors of which have addresses ordered substantially sequentially along this track, and at least one secondary track (P_{B}) nested between successive loops of the main track in such a way that the spacing of the loops remains the same over substantially the whole of the disk, sectors of the secondary track and the corresponding sectors of the adjacent part of the main track in a given radial direction bearing the same addresses (n to n+Q) in such a way as to form two parts of substantially the same size of a protection zone (ZDP), said disk being characterized in that two sectors with the same address in the protection zone are shifted by a interval of k sectors as measured along the main track, k being any predetermined algebraic number.

11. The disk as claimed in claim 10, in which the passing from the main track zone (P_{A}), with given initial spacing of the spiral (SP), to the start of the protection zone (ZDP), with spacing of the main track double the initial spacing, and the passing from the end of this protection zone to the main track zone with initial spacing are performed respectively by an acceleration zone (Z_{Acc}) and a deceleration zone (Z_{Dec}), said disk being characterized in that the useful part of the secondary track (P_{B}) is preceded and followed by burnt infill information (F_{Acc}, F_{Dec}) starting in the acceleration zone up to the start of the useful part on the one hand and extending, on the other hand, from the end of the useful part up until the deceleration zone.

12. The disk as claimed in one of claims 10 or 11, characterized in that said gap of k sectors is chosen in such a way as to correspond substantially to half a spiral turn in the zone considered.

13. The disk as claimed in any one of claims 10 to 12, characterized in that the main and secondary tracks are disposed over the disk so that a sector with given address n on the secondary track lies substantially opposite the sector with address (n+k) on the main track.
